(19) United States
(12) Patent Application Publication
(10) Pub. No.: US 2025/0320620 A1
(43) Pub. Date: Oct. 16, 2025

(54) EXTRACTION OF CALCIUM AND OTHER VALUABLE ELEMENTS VIA SONIC STIMULATION AND SEQUENTIAL ELECTROLYSIS

(71) Applicant: The Regents of the University of California, Oakland, CA (US)

(72) Inventors: Gaurav N. Sant, Los Angeles, CA (US); Ross Arnold, Los Angeles, CA (US); Dante Simonetti, Los Angeles, CA (US); Xin Chen, Los Angeles, CA (US); David Jassby, Los Angeles, CA (US); Thomas J. Traynor, Los Angeles, CA (US)

(21) Appl. No.: 18/866,317

(22) PCT Filed: May 23, 2023
(86) PCT No.: PCT/US2023/067355

§ 371 Date: Nov. 15, 2024

Related U.S. Application Data
(60) Provisional application No. 63/344,795, filed on May 23, 2022.

(51) Int. Cl. C25C 1/02; C25C 1/08; C25C 1/12; C25C 1/16; C25C 7/04; C25C 7/06

(52) U.S. Cl. CPC C25C 1/02; C25C 1/08; C25C 1/12; C25C 1/16; C25C 7/04; C25C 7/06

(57) ABSTRACT

Provided herein are assemblies and methods for calcium and/or other valuable element extraction. An assembly includes a dissolution tank defining an interior chamber having a first inlet, a second inlet, and a mixture outlet. The dissolution tank is configured to combine one or more substrates and a solvent into a mixture. The one or more substrates contain one or more target elements. The assembly optionally includes a sonic probe, a sonic plate, or both the sonic probe and the sonic plate. The assembly further optionally includes a membrane concentrator fluidically coupled to the mixture outlet of the dissolution tank. The assembly further includes a sequential electrolytic precipitation reactor fluidically coupled to the mixture outlet of the dissolution tank or the membrane concentrator, if present. Each precipitate outlet is configured to output a precipitate of the one or more target element.

### RELATED APPLICATION

This application claims the benefit of priority to U.S. Provisional Application No. 63/344,795, filed May 23, 2022, the contents of which are fully incorporated by reference herein.

### BACKGROUND

Lithium, magnesium, and calcium are key raw materials for applications such as lithium-ion batteries, magnesium-aluminum alloys, and calcium compounds, respectively. Moreover, lithium compounds are used in many commercial applications including batteries, glass, ceramics, lubricating greases, and other industrial products. Global lithium consumption has significantly increased in the recent decades and is projected to reach 0.2 million tons by 2030.

Copper, nickel, cobalt, and cadmium are also key raw materials for various applications such as metal alloys, magnets, semiconductors, batteries, automotive applications (including electric vehicles), and solar panels, among other commercial uses.

These elements may be extracted from natural precursors and/or industrial wastes (e.g., alkaline industrial wastes) by first grinding the solid sources into particles having a median size as low as 5 μm followed by acid-leaching. However, these techniques are energy intensive and can be harmful to the environment. Moreover, providing an acid stream for acid-leaching of the particles adds expense, requires additional energy (e.g., the energy to manufacture, transport, and store the acid), and increases environmental impact.

### SUMMARY OF THE INVENTION

Embodiments of the present disclosure generally relate to apparatuses and processes for the selective extraction of calcium and other valuable elements via sonic stimulation, membrane concentration and/or sequential electrolytic precipitation. More specifically, the present disclosure relates to systems and processes for the selective extraction of alkali, alkaline earth, and/or transition metals or other suitable elements from geological precursors and/or industrial waste materials.

The present disclosure provides in some embodiments a method comprising:
combining, in a dissolution tank, one or more substrates comprising one or more target elements, and a solvent to form a mixture;
optionally applying sonic energy, with or without added acidity, to the dissolution tank;
providing the mixture to one or more membrane concentrators to increase the concentration of the target-element in the mixture;
providing the mixture to a sequential electrolytic precipitation reactor; and
electrolytically precipitating each of the one or more target elements from the sequential electrolytic precipitation reactor to form one or more target-element-rich precipitates.

In other embodiments, the disclosure provides and assembly An assembly for extracting a target element, comprising:
a dissolution tank defining an interior chamber having a first inlet, a second inlet, and a mixture outlet, wherein the dissolution tank is configured to receive one or more substrates through the first inlet and a solvent through the second inlet, wherein the one or more substrates comprise one or more target element, and wherein the dissolution tank is configured to combine the one or more substrates and the solvent into a mixture; optionally a sonic probe disposed within the interior chamber and configured to provide sonic energy to the mixture, a sonic plate in contact with the dissolution tank and configured to provide sonic energy to the mixture, or both the sonic probe and the sonic plate; and
a sequential electrolytic precipitation reactor fluidically coupled to the mixture outlet of the dissolution tank, wherein the sequential electrolytic precipitation reactor comprises one or more precipitate outlets and one or more anolyte outlets configured to output one or more anolytes, each precipitate outlet configured to output a target element-rich precipitate.

### BRIEF DESCRIPTION OF THE SEVERAL VIEWS OF THE DRAWINGS

FIG. 1A illustrates a process flow diagram for the extraction of calcium and/or other metals from precursors using sonic stimulation, membrane concentration, and sequential electrolytic precipitation in a cascading arrangement of reactors in accordance with an embodiment of the present disclosure.

FIG. 1B illustrates a process flow diagram for the extraction of calcium and/or other metals from precursors using sonic stimulation, membrane concentration, and sequential electrolytic precipitation along a continuous reactor in accordance with an embodiment of the present disclosure.

FIG. 2A illustrates combined Pourbaix diagrams showing the equilibrium regions of aqueous species of various metals with varying pH and reduction potentials at ion activities of 0.1 mM.

FIG. 2B illustrates a contour plot of electric intensity (EEI) as a function of inlet calcium concentration and of the ratio between current (I) and flow rate (R) for the electrolytic production of Ca(OH)₂.

FIGS. 3A-3C illustrate the effect of sonication on the dissolution of elements of interest (e.g., Mg, Ni, and Si). Si is shown as it is the limiting factor of the dissolution of silicate rocks. For each element, a clear effect of sonication is observed, thereby validating the use of this technique to enhance mineral leaching.

FIG. 4 illustrates the congruency of the dissolution of Mg and Ni in regard to Si. This was performed by comparing the total amount of the species that had been dissolved divided by the total amount of Si that had been dissolved. As Si is the limiting factor of the dissolution, congruency is an important indicator of how Si decrease the dissolution rate of other species. Here, it is shown that the Mg and Ni are dissolved faster than Si; this trend was observed for all the duration of the experiments.

FIGS. 5A & 5B illustrate the results of a cascade precipitation in batch. NaOH was manually added to a solution containing Mg and Ca to increase the pH. FIG. 5A illustrates the results based on solution analysis. It is shown that Mg precipitates at lower pH than Ca, allowing the precipitation of brucite (Mg hydroxide, conversion ˜100%) at 9<pH<11. After pH reaches 12.5 or higher, Ca precipitate to form portlandite (Ca hydroxide). FIG. 5B illustrates results based on solid analysis (thermo-gravimetric analysis). Results show precipitation of mainly brucite at pH 10.5 with contamination of portlandite and carbonates. At pH 13, mainly portlandite was precipitated with contamination of carbonates.

### DETAILED DESCRIPTION

Industrial alkaline wastes and abundant mineral species are precursors that possess large quantities of valuable metal elements, for example, alkali metals (e.g., lithium, sodium, potassium, rubidium), alkaline earth metals (e.g., beryllium, magnesium, calcium), and/or transition metals (e.g., cobalt, cadmium, nickel, copper, platinum, gold, silver). These precursors, however, rarely bear only one element. For example, steel slags and fly ashes may include significant amounts of calcium, iron, and/or magnesium. Aqueous solutions leached from these precursors (e.g., steel slag and/or fly ash) may contain several metallic and/or semi-metallic species in solution. Each species may include one or more metals that are useful for different applications and, thus, sequential removal of each species at high purity is desirable. The present disclosure provides a system and process combining sonic stimulation, acid dissolution, and, optionally, membrane filtration, to leach metals from precursor solids, followed by a series of sequential electrolytic precipitation steps to obtain high-purity output of each metal and/or semi-metal species in the aqueous solution. The present invention advantageously uses sonic (e.g., ultrasonic or megasonic) stimulation of a mixture having a substrate and a solvent, which can be used to selectively extract the target element(s) (e.g., metals such as Ca, Li, and/or Mg) from the substrate.

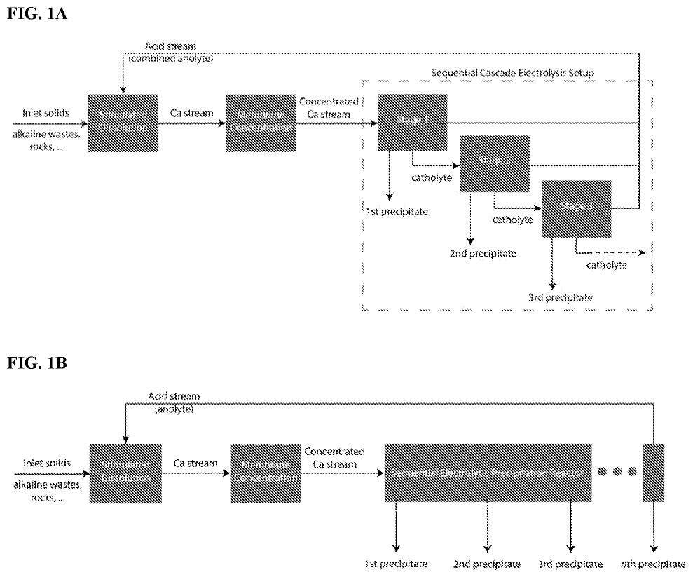

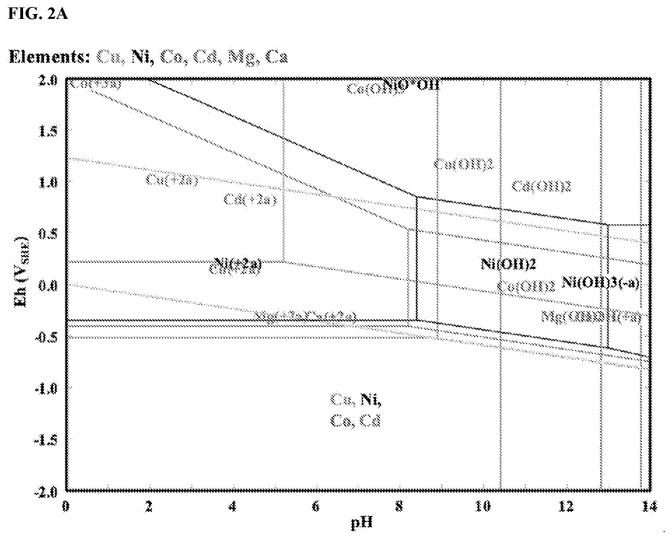

FIG. 1A illustrates a process flow diagram for the extraction of calcium and/or other metals from abundant precursors using sonic stimulation, membrane concentration, and sequential electrolytic precipitation in a cascading arrangement of reactors. As shown in FIG. 1A, one or more substrates are received at an inlet of a stimulated dissolution reactor. The substrate may be a solid substrate, such as a particulate substrate. For example, the substrate(s) may include alkaline industrial wastes, rocks, minerals, etc. In various embodiments, the stimulated dissolution (e.g., leaching) reactor combines an acid stream with the substrate(s) received at the inlet to form a mixture. In various embodiments, as will be described in more detail below, the acid stream is recycled from one or more outputs (e.g., an anolyte) of the sequential electrolytic precipitation reactor (e.g., via a cascade or a continuous configuration).

FIG. 1B illustrates a process flow diagram for the extraction of calcium and/or other metals from abundant precursors using sonic stimulation, membrane concentration, and sequential electrolytic precipitation along a continuous reactor.

In various embodiments, the stimulated dissolution reactor applies sonic energy to the mixture to thereby break down the solids into finer particles to increase dissolution. Sonic stimulation offers a rapid, low-energy, additive-free route compared to conventional grinding and leaching. In various embodiments, the stimulated dissolution reactor performs ultrasonic stimulation. Ultrasonic stimulation may also be referred to herein as ultrasonication, sonic stimulation, or ultrasonic perturbation. In various embodiments, the stimulated dissolution reactor performs megasonic stimulation. In various embodiments, calcium and/or other metals are extracted from the inlet solids via sonic stimulation at ultrasonic (20-500 kHz) or megasonic (>500 kHz) frequencies in an acidic medium.

In various embodiments, a solvent is provided into a reactor (e.g., a stimulated dissolution tank). In various embodiments, the solvent includes at least one of: water, alcohols (e.g., methanol, ethanol, isopropanol, etc.), acetone, organic solvents (e.g., pentane, hexane, benzene, toluene, diethyl ether, tetrahydrofuran, chloroform, etc.), polyethylene glycol, hydrogen peroxide, and any combination thereof. In some embodiments, the solvent has a pH ranging from about 5.5 to about 8.5, about 6 to about 8, or about 6.5 to about 7.5. In other embodiments, the solvent provided to the reactor has a pH ranging from about 1 to about 6, about 1 to about 5, or about 1 to about 4. In other embodiments, the solvent has a pH ranging from about 1 to about 5. In various embodiments, one or more solid substrates having one or more target elements is provided to the reactor. In various embodiments, the solid substrate(s) and solvent are provided to the reactor via the same inlet. In various embodiments, the solid substrate and solvent are provided to the reactor via separate inlets. In various embodiments, the solvent and solid substrate(s) are provided to the reactor at the same flow rate (e.g., mass flow rate, volumetric flow rate). In various embodiments, the solvent and solid substrate(s) are provided to the reactor at a different flow rate (e.g., mass flow rate, volumetric flow rate).

In various embodiments, the solvent includes a mixture of a mineral acid and water. In various embodiments, the mineral acid is selected from: hydrofluoric acid, hydrochloric acid, hydrobromic acid, hydroiodic acid, boric acid, phosphoric acid, nitric acid, perchloric acid, sulfuric acid, and any combination thereof. In various embodiments, the concentration of the mineral acid in the solvent and acid mixture is up to about 1 mol/L. In various embodiments, a pH of the mixture is about 0 to about 7, preferably about 1 to about 5.

In various embodiments, the solvent includes a mixture of an organic acid and water. In various embodiments, the organic acid is selected from: acetic acid, acetylsalicylic acid, carbonic acid, citric acid, and any combination thereof. In various embodiments, the concentration of the organic acid in the solvent and acid mixture is up to about 1 mol/L. In various embodiments, a pH of the solvent and acid mixture is about 0 to about 7, preferably about 1 to about 5.

In certain embodiments, the methods disclosed herein are performed at about pH 1. In certain embodiments, the methods disclosed herein are performed at about pH 2. In certain embodiments, the methods disclosed herein are performed at about pH 3. In certain embodiments, the methods disclosed herein are performed at about pH 4. In certain embodiments, the methods disclosed herein at performed are about pH 5. In certain embodiments, the methods disclosed herein are performed at about pH 6. In certain embodiments, the methods disclosed herein are performed at about pH 7. In certain embodiments, the methods disclosed herein are performed at about pH 8. In certain embodiments, the methods disclosed herein are performed at about pH 9. In certain embodiments, the methods disclosed herein are performed at about pH 10. In certain embodiments, the methods disclosed herein are performed at about pH 11. In certain embodiments, the methods disclosed herein are performed at about pH 12. In certain embodiments, the methods disclosed herein are performed at about pH 13. In certain embodiments, the methods disclosed herein are performed at about pH 14.

In various embodiments, ultrasonic stimulation is applied to the stimulated dissolution tank. In various embodiments, the ultrasonic frequency is about 18 kHz to about 2000 kHz. In various embodiments, the ultrasonic stimulation frequency is about 20 kHz to about 40 kHz. In various embodiments, the ultrasonic stimulation frequency is about 800 kHz to about 1200 kHz. In various embodiments, the ultrasonic stimulation frequency is greater than or equal to about 18 kHz. In various embodiments, the ultrasonic stimulation frequency is less than or equal to about 2000 kHz. In various embodiments the ultrasonic stimulation frequency is about 20 kHz. In various embodiments the ultrasonic stimulation frequency is about 30 kHz. In various embodiments the ultrasonic stimulation frequency is about 40 kHz. In various embodiments the ultrasonic stimulation frequency is about 50 kHz. In various embodiments the ultrasonic stimulation frequency is about 60 kHz. In various embodiments the ultrasonic stimulation frequency is about 70 kHz. In various embodiments the ultrasonic stimulation frequency is about 80 kHz. In various embodiments the ultrasonic stimulation frequency is about 90 kHz. In various embodiments the ultrasonic stimulation frequency is about 100 kHz. In various embodiments the ultrasonic stimulation frequency is about 200 kHz. In various embodiments the ultrasonic stimulation frequency is about 300 kHz. In various embodiments the ultrasonic stimulation frequency is about 400 kHz. In various embodiments the ultrasonic stimulation frequency is about 500 kHz. In various embodiments the ultrasonic stimulation frequency is about 600 kHz. In various embodiments the ultrasonic stimulation frequency is about 700 kHz. In various embodiments the ultrasonic stimulation frequency is about 800 kHz. In various embodiments the ultrasonic stimulation frequency is about 900 kHz. In various embodiments the ultrasonic stimulation frequency is about 1000 kHz (1 MHz). In various embodiments the ultrasonic stimulation frequency is about 1100 kHz (1.1 MHz). In various embodiments the ultrasonic stimulation frequency is about 1200 kHz (1.2 MHz). In various embodiments the ultrasonic stimulation frequency is about 1300 kHz (1.3 MHz). In various embodiments the ultrasonic stimulation frequency is about 1400 kHz (1.4 MHZ). In various embodiments the ultrasonic stimulation frequency is about 1500 kHz (1.5 MHz). In various embodiments the ultrasonic stimulation frequency is about 1600 kHz (1.6 MHz). In various embodiments the ultrasonic stimulation frequency is about 1700 kHz (1.7 MHz). In various embodiments the ultrasonic stimulation frequency is about 1800 kHz (1.8 MHz). In various embodiments the ultrasonic stimulation frequency is about 1900 kHz (1.9 MHz). In various embodiments the ultrasonic stimulation frequency is about 2000 kHz (2 MHz).

In various embodiments, the ultrasonic stimulation is provided by a sonic probe that is at least partially submerged in the solvent-substrate mixture. In various embodiments, the ultrasonic stimulation is provided by one or more ultrasonic plates in contact with the reactor. In still further embodiments, the ultrasonic stimulation is provided by both a sonic (e.g., ultrasonic) probe and a sonic (e.g., ultrasonic) plate. In various embodiments, the sonic probe causes agitation of the solvent due to the rapid motion of the probe. In various embodiments, particularly where the ultrasonic plate is used for sonic stimulation, a stirrer may be disposed within the reactor to ensure thorough mixing of the solvent. In various embodiments, an effluent liquid stream from the reactor is enriched in the target element. In various embodiments, as the solid substrate to-be-leached contains other less-soluble elements (e.g., non-target materials), a portion of the solid substrate remains undissolved, and may be removed as spent solid. In various embodiments, the spent solid is passed through a spent solid outlet.

In various embodiments, ultrasonic stimulation of the solid particles within the substrate-solvent mixture allows for larger particle sizes to be effective for leaching compared to acid leaching, lowering any required grinding energy of the process. In various embodiments, the particles may be about 100 μm or greater. In various embodiments, the particles have an average diameter of about 500 nm to 5 mm, about 100 μm to about 5 mm, about 500 μm to about 5 mm, or about 500 μm to about 3 mm. In various embodiments, the dissolution tank may be operated as a continuous flow reactor. In various embodiments, the dissolution tank may be operated as a batch reactor. In various embodiments, the dissolution tank may be operated as a plug flow reactor (PFR) mode. In various embodiments, the dissolution tank may be operated as a fixed- or fluidized-bed reactor. In various embodiments, the particular choice of mode may depend on dissolution rate of the target element.

In various embodiments, an output stream from the stimulated dissolution reactor is optionally provided to a membrane concentrator. In various embodiments, the membrane concentrator performs nanofiltration and/or reverse osmosis. In various embodiments, the permeate from nanofiltration is provided to the electrolysis anode. In various embodiments, the membrane concentrator performs filtration. In various embodiments, the membrane concentrator may perform filtration to filter particles that are larger than a predetermined size (e.g., diameter). In various embodiments, the membrane concentrator selectively filters multivalent ions and allows monovalent ions to pass through. In other embodiments, nanofiltration is based on ion charge. In still other embodiments, nanofiltration is based on both ion size and ion charge. In various embodiments, the membrane concentrator outputs a concentrated retentate stream of ionic species (e.g., a concentrated calcium cation stream).

In various embodiments using the membrane concentrator, the retentate of the membrane concentrator is provided to a sequential electrolytic precipitation reactor. In various embodiments, a membrane concentrator is not used and the output of the stimulated dissolution reactor is provided to the sequential electrolytic precipitation reactor. In various embodiments, such as shown in FIG. 1A, the sequential electrolytic precipitation reactor has a cascading arrangement with two or more stages within the reactor system. In various embodiments, each stage is configured to output a precipitate comprising a desired element. For example, a first stage may output a first precipitate, a second stage may output a second precipitate that is different from the first precipitate, and a third stage may output a third precipitate that is different from the first and second precipitates. In various embodiments, each stage outputs a different precipitate. In various embodiments, each stage is configured to output a precipitate at a different pH. In various embodiments, each stage is comprises electrode materials that have different electrical conductivities.

In various embodiments, each prior stage outputs a catholyte to the next stage in the cascading arrangement. In various embodiments, each catholyte output has at least some of the target element removed from solution. In various embodiments, each stage is configured to remove a single metal (e.g., Ca) such that the subsequent catholyte output has a decreased concentration of the metal (e.g., Ca). For example, the first, second, and third stages may be configured to precipitate nickel, magnesium, and calcium, respectively. In this example, the pH increases from stage 1 to stage 2 and then from stage 2 to stage 3.

In various embodiments, each stage outputs an anolyte. In various embodiments, the anolyte is acidic (e.g. has a pH of less than 7). In various embodiments, the anolyte outputs from each stage are returned to the stimulated dissolution reactor to thereby provide an acidic stream for leaching. In various embodiments, the anolyte output has a pH of about 0 to about 7. In other embodiments, the pH of the anolyte is about 1 to about 5.

In various embodiments, sonic stimulation promotes rapid extraction of metallic elements from solid amorphous and crystalline precursors in an energy-efficient manner, facilitating a rapid process and lowering energy demand by reducing the amount of acidity which must be used. In various embodiments, the optional membrane concentration step, such as nanofiltration or reverse osmosis, is included in order to increase concentration of aqueous metal species in the retentate. In various embodiments, the efficiency of electrochemical precipitation is increased as the concentration of precipitating species is increased, and as such a membrane concentration step reduces the overall energy demand of the process.

In an electrolytic system, reduction occurs at the cathode and oxidation occurs at the anode. The anodic reaction (2H₂O→4H⁺+O₂) advantageously produces the acidity sufficient for elemental extraction in the dissolution tank. At the cathode, the reduction of water (2H₂O→H₂+2OH⁻) takes place, which releases alkalinity to raise the pH. In various embodiments, metal hydroxides precipitate when the pH exceeds certain values. In various embodiments, above certain electrode potential values, reduction of the metal ions themselves takes place, leading to precipitation of the dissolved species as elemental metals (i.e., electroplating). In various embodiments, the pH values that lead to metal hydroxide precipitation and the electrode potentials that lead to metal precipitation are shown for six example metals in Table 1 below.

Table 1. Exemplary metal ions and their corresponding electroplating reduction potentials, E, (vs. standard hydrogen electrode electric potential, VSHE) and metal hydroxide precipitation pH-values. Reduction potentials were calculated using an ionic activity of 0.1 mM. Precipitation pH-values represent the values at which metal hydroxide solubility is less than 1 ppm. (All values are determined at the metal ion activity of 0.1 mM).

TABLE 1

| Metal Ion | E (V _{SHE}) | Metal Hydroxide | pH-value |
|---|---|---|---|
| Cu²⁺ | 0.22 | Cu(OH)₂ | 5.2 |
| Ni²⁺ | −0.38 | Ni(OH)₂ | 8.4 |
| Co²⁺ | −0.40 | Co(OH)₂ | 8.2 |
| Cd²⁺ | −0.52 | Cd(OH)₂ | 8.9 |
| Mg²⁺ | −2.48 | Mg(OH)₂ | 10.4 |
| Ca²⁺ | −2.96 | Ca(OH)₂ | 13.8 |

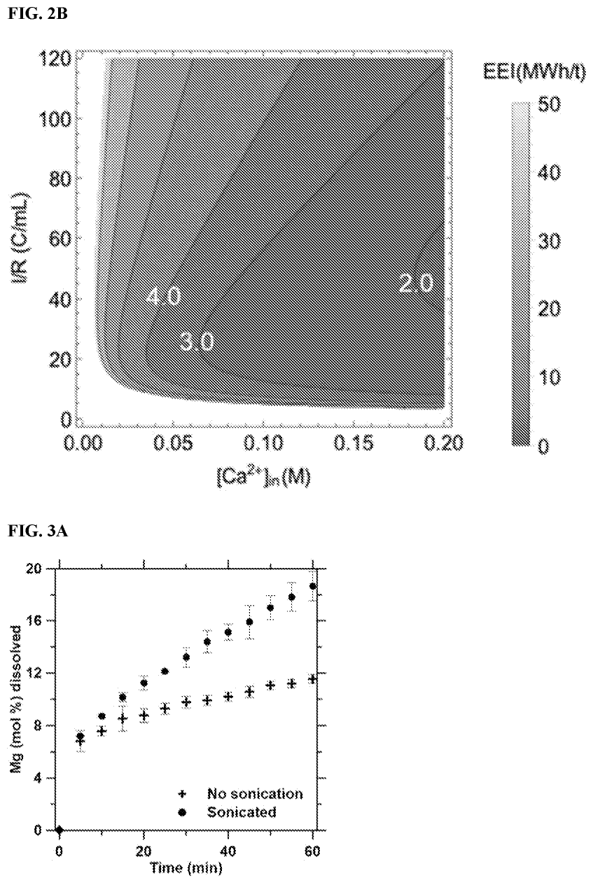

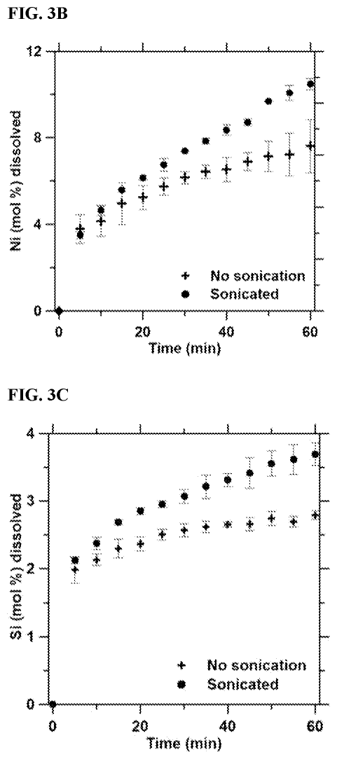

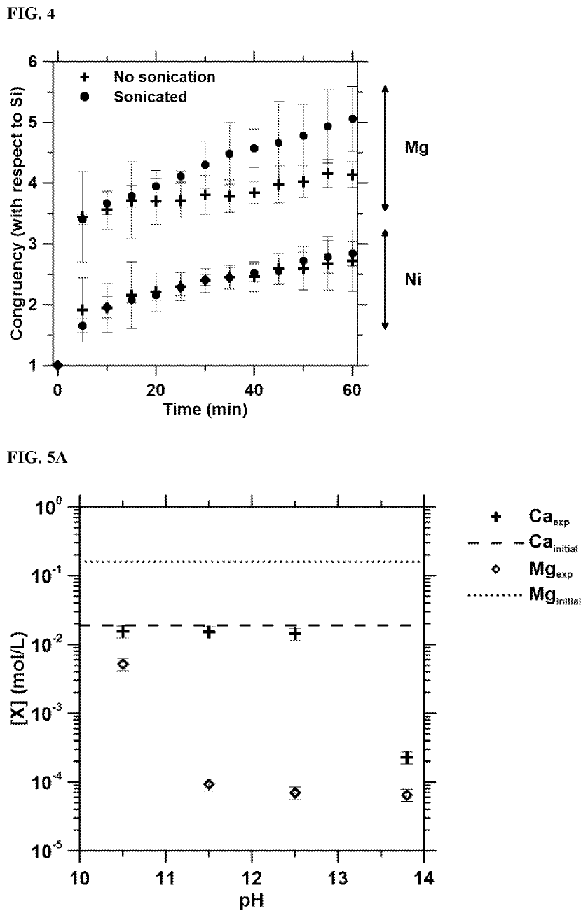

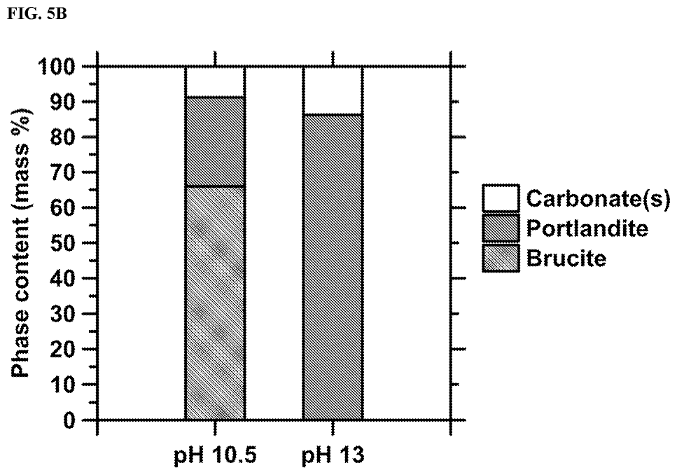

In various embodiments, the reduction potentials and the metal hydroxide precipitation pH-values were determined from Pourbaix diagrams, such as in FIG. 2A, with metal ion activities of 0.1 mM. In various embodiments, the values in Table 1 are sensitive to activity values. For example, the equilibrium pH of saturated Ca(OH)₂ in water is typically in the range of pH 12.4-12.8, but this corresponds to a Ca activity of ˜100 mM. When Ca activity is fixed at 0.1 mM, the precipitation pH is much higher at about 13.8. In various embodiments, as shown in FIG. 1A, the metals are sequentially removed from the aqueous stream through sequential increases in pH and/or reduction potential with each subsequent electroprecipitation step. In various embodiments, as shown in FIG. 1B, metals are sequentially removed along the length of a single electrolytic precipitation reactor, in which the pH and/or reduction potential increases along the length, causing different metals to precipitate out as reduced metals or as metal hydroxides along the length, until the nth metal is removed. In each configuration, each metal is precipitated as a near-pure elemental metal or a metal hydroxide, performing the precipitation and separation steps simultaneously. In various embodiments, the catholyte flows continuously through each system. In various embodiments, where the precipitation reactor includes two or more stages in series, each previous stage outputs a catholyte to the subsequent stage. In various embodiments, the anolyte flows continuously. In various embodiments, the anolyte flow mirrors the catholyte flow. In various embodiments, the anolyte is extracted after each electrolyzer (as shown in FIG. 1A). In various embodiments, the anolyte is extracted along the continuous electrolytic precipitation reactor (as shown in FIG. 1B), after which the anolyte stream is returned to the dissolution tank as the solvent.

FIG. 2A illustrates combined Pourbaix diagrams. In particular, the combined Pourbaix diagrams show the equilibrium regions of aqueous species of Ca, Mg, Cd, Co, Ni, and Cu with varying pH and reduction potential at ion activities of 0.1 mM.

FIG. 2B illustrates a contour plot of electric energy intensity (EEI) as a function of inlet calcium concentration and of the ratio between current (I) and flow rate (R) for the electrolytic production of Ca(OH)₂.

In some embodiments, the target-element-rich precipitate comprises a target element hydroxide or an elemental form of the target element. In some embodiments, the target element is a metal, such as an alkali metal, one or more alkaline earth metal, or one or more transition metal. In some embodiments, the alkali metal comprises lithium. In some embodiments, the alkaline earth metal comprises magnesium or calcium. In some embodiments, the one or more transition metals comprises nickel, copper, nickel, cobalt, and/or cadmium.

In various embodiments, the overall EEI of Ca(OH)₂ production via an electrolytic pathway is shown in FIG. 2B. The energy inputs for this process are the electricity required for sonic stimulation, membrane concentration (if included), electrolysis, and water pumping. As such, the only CO₂ emissions are those required to produce electricity and the use of renewable electricity further reduces the CO₂ produced by this process. Accordingly, the present invention advantageously provides a significantly lower-CO₂ pathway for obtaining metals when compared to traditional high-temperature smelting processes for extracting metals from ores. For example, the decomposition of calcite to produce lime (CaO) for Ca(OH)₂ generation releases 0.59 tons of CO₂ per ton of Ca(OH)₂, which does not include emissions to produce heat to induce the decomposition of calcite. Indeed, primary mineral and metal production is estimated to produce 10% of global anthropogenic CO₂ emissions, which could be eliminated by 90% or more by using a leaching and electrolysis process powered by renewable electricity. Additionally, generating acid in situ for element extraction removes the >0.2 MWh/t of solubilized metal ions that would be needed to produce nitric acid in a stoichiometric amount. Making use of waste materials and/or abundant rocks, as the present invention allows, greatly expands the availability of feedstocks available for metal extraction and reduces the amount of waste generated when compared to conventional methods, assisting with process circularity.

What is claimed is:

1. A method for extracting a target element, comprising:
combining, in a dissolution tank, one or more substrates comprising one or more target elements, and a solvent to form a mixture;
optionally applying sonic energy to the dissolution tank;
providing the mixture to a sequential electrolytic precipitation reactor; and
electrolytically precipitating each of the one or more target element from the sequential electrolytic precipitation reactor to form one or more target-element-rich precipitates.

2. The method of claim 1, further comprising: outputting one or more anolytes from the sequential electrolytic precipitation reactor, wherein the anolyte is provided to the dissolution tank as a solvent.

3. The method of claim 1 or 2, further comprising providing the mixture to a membrane concentrator prior to the sequential electrolytic precipitation reactor.

4. The method of claim 3, wherein the membrane concentrator is configured to perform nanofiltration on the mixture.

5. The method of claim 4, wherein the nanofiltration selectively concentrates specific cations within the system while remaining unselective to other cations.

6. The method of claim 3, wherein the membrane concentrator is configured to perform reverse osmosis on the mixture.

7. The method of any one of claims 1 to 6, wherein the sequential electrolytic precipitation reactor comprises two or more stages.

8. The method of claim 7, wherein the two or more stages are fluidically connected in series and/or in parallel, each subsequent stage configured to receive a catholyte and/or anolyte from a previous stage.

9. The method of claim 7, wherein the two or more stages are fluidically connected in series.

10. The method of claim 7, wherein the two or more stages are fluidically connected in parallel.

11. The method of any one of claims 8-10, wherein each stage is configured to output one of the target-element-rich precipitates.

12. The method of any one of claims 1 to 6, wherein the sequential electrolytic precipitation reactor is a single reactor having two or more outlets, each outlet configured to output one of the target-element-rich precipitates.

13. The method of any one of claims 1-12, wherein the method is performed at about pH 1.

14. The method of any one of claims 1-12, wherein the method is performed at about pH 2.

15. The method of any one of claims 1-12, wherein the method is performed at about pH 3.

16. The method of any one of claims 1-12, wherein the method is performed at about pH 4.

17. The method of any one of claims 1-12, wherein the method is performed at about pH 5.

18. The method of any one of claims 1-12, wherein the method is performed at about pH 6.

19. The method of any one of claims 1-12, wherein the method is performed at about pH 7.

20. The method of any one of claims 1-12, wherein the method is performed at about pH 8.

21. The method of any one of claims 1-12, wherein the method is performed at about pH 9.

22. The method of any one of claims 1-12, wherein the method is performed at about pH 10.

23. The method of any one of claims 1-12, wherein the method is performed at about pH 11.

24. The method of any one of claims 1-12, wherein the method is performed at about pH 12.

25. The method of any one of claims 1-12, wherein the method is performed at about pH 13.

26. The method of any one of claims 1-12, wherein the method is performed at about pH 14.

27. The method of any one of claims 1-12, wherein the sequential electrolytic precipitation reactor has a pH gradient along the length such that each target-element-rich precipitate forms at a unique outlet.

28. The method of any one of claims 1-27, wherein the target-element-rich precipitate comprises a target element hydroxide or an elemental form of the target element.

29. The method of any one of claims 1-28, wherein the one or more target elements comprise one or more alkali metals, one or more alkaline earth metals, or one or more transition metals.

30. The method of any one of claims 1-29, wherein the one or more target elements comprise one or more alkali metals.

31. The method of claim 30, wherein the one or more alkali metals comprise lithium.

32. The method of any one of claims 1-31, wherein the one or more target elements comprise one or more alkaline earth metals.

33. The method of claim 32, wherein the one or more alkaline earth metals comprise magnesium.

34. The method of claim 32 or 33, wherein the one or more alkaline earth metals comprise calcium.

35. The method of any one of claims 1-34, wherein the one or more target elements comprise one or more transition metals.

36. The method of claim 35, wherein the one or more transition metals comprise nickel, copper, cobalt, and/or cadmium.

37. The method of claim 35 or 36, wherein the one or more transition metals comprise nickel.

38. The method of any one of claims 35-37, wherein the one or more transition metals comprise copper.

39. The method of any one of claims 35-38, wherein the one or more transition metals comprise cobalt.

40. The method of any one of claims 35-39, wherein the one or more transition metals comprise cadmium.

41. The method of any one of claims 1-40, wherein the sonic energy has a frequency of about 18 kHz to about 2 MHz.

42. The method of claim 41, wherein the sonic energy has a frequency of about 20 kHz to about 40 kHz.

43. The method of claim 41, wherein the sonic energy has a frequency of about 800 kHz to about 1200 kHz.

44. The method of claim 41, wherein the sonic energy has a frequency of about 18 kHz.

45. The method of claim 41, wherein the sonic energy has a frequency of about 20 KHz.

46. The method of claim 41, wherein the sonic energy has a frequency of about 30 KHz.

47. The method of claim 18, wherein the sonic energy has a frequency of about 40 kHz.

48. The method of claim 18, wherein the sonic energy has a frequency of about 50 kHz.

49. The method of claim 18, wherein the sonic energy has a frequency of about 60 KHz.

50. The method of claim 18, wherein the sonic energy has a frequency of about 70 KHz.

51. The method of claim 18, wherein the sonic energy has a frequency of about 80 kHz.

52. The method of claim 18, wherein the sonic energy has a frequency of about 90 kHz.

53. The method of claim 18, wherein the sonic energy has a frequency of about 100 kHz.

54. The method of claim 41, wherein the sonic energy has a frequency of about 1000 kHz (1 MHz).

55. The method of claim 41, wherein the sonic energy has a frequency of about 1100 kHz (1.1 MHz).

56. The method of claim 41, wherein the sonic energy has a frequency of about 1200 kHz (1.2 MHz).

57. The method of claim 41, wherein the sonic energy has a frequency of about 1300 kHz (1.3 MHz).

58. The method of claim 41, wherein the sonic energy has a frequency of about 1400 kHz (1.4 MHz).

59. The method of claim 41, wherein the sonic energy has a frequency of about 1500 kHz (1.5 MHz).

60. The method of claim 41, wherein the sonic energy has a frequency of about 1600 kHz (1.6 MHz).

61. The method of claim 41, wherein the sonic energy has a frequency of about 1700 kHz (1.7 MHz).

62. The method of claim 41, wherein the sonic energy has a frequency of about 1800 kHz (1.8 MHz).

63. The method of claim 41, wherein the sonic energy has a frequency of about 1900 kHz (1.9 MHz).

64. The method of claim 41, wherein the sonic energy has a frequency of about 2000 kHz (2 MHz).

65. The method of any one of claims 1-64, wherein the sonic energy is provided at one or more resonant frequencies of the one or more substrates.

66. The method of any one of claims 1-65, wherein the one or more substrates comprise particles having a median diameter of 0.1 nm to about 10 cm.

67. The method of any one of claims 1-65, wherein the one or more substrates comprise particles having a median diameter of 0.5 nm to about 5 cm.

68. The method of any one of claims 1-65, wherein the one or more substrates comprise particles having a median diameter of about 1 μm to about 5 mm.

69. The method of any one of claims 1-68, wherein the solvent has a pH of about 0 to about 7.

70. The method of any one of claims 1-69, wherein the one or more substrates comprise one or more of: fly ash, alkaline wastes, and rocks.

71. The method of any one of claims 1-70, wherein the one or more substrates comprises fly ash.

72. The method of any one of claims 1-71, wherein the one or more substrates comprise alkaline wastes.

73. The method of any one of claims 1-72, wherein the one or more substrates comprise rocks.

74. The method of any one of claims 1-73, wherein dissolution tank further comprises a stirring device, and the method further comprising stirring the mixture and the solvent.

75. The method of any one of claims 1-74, wherein the dissolution tank is configured to operate as a batch reactor.

76. The method of any one of claims 1-74, wherein the dissolution tank is configured to operate as a plug flow reactor.

77. The method of any one of claims 1-74, wherein the dissolution tank is configured to operate as a continuous flow reactor.

78. The method of any one of claims 1-74, wherein the dissolution tank is configured to operate as a fixed-bed reactor.

79. The method of any one of claims 1-74, wherein the dissolution tank is configured to operate as a fluidized-bed reactor.

80. The method of any one of claims 1-79, wherein the method comprising applying sonic energy to the mixture.

81. An assembly for extracting a target element, comprising:
a dissolution tank defining an interior chamber having a first inlet, a second inlet, and a mixture outlet, wherein the dissolution tank is configured to receive one or more substrates through the first inlet and a solvent through the second inlet, wherein the one or more substrates comprise one or more target element, and wherein the dissolution tank is configured to combine the one or more substrates and the solvent into a mixture;
optionally a sonic probe disposed within the interior chamber and configured to provide sonic energy to the mixture, a sonic plate in contact with the dissolution tank and configured to provide sonic energy to the mixture, or both the sonic probe and the sonic plate; and
a sequential electrolytic precipitation reactor fluidically coupled to the mixture outlet of the dissolution tank, wherein the sequential electrolytic precipitation reactor comprises one or more precipitate outlets and one or more anolyte outlets configured to output one or more anolytes, each precipitate outlet configured to output a target element-rich precipitate.

82. The assembly of claim 81, further comprising a membrane concentrator fluidically coupled to the mixture outlet of the dissolution tank and to the electrolytic precipitation reactor.

83. The assembly of claim 82, wherein the membrane concentrator is configured to perform nanofiltration on the mixture.

84. The assembly of claim 83, wherein the nanofiltration selectively concentrates some of the cations in solution.

85. The assembly of claim 84, wherein the membrane concentrator is configured to perform reverse osmosis on the mixture.

86. The assembly of any one of claims 81 to 85, wherein the sequential electrolytic precipitation reactor comprises two or more stages.

87. The assembly of claim 86, wherein the two or more stages are fluidically connected in series, each subsequent stage configured to receive a catholyte from a previous stage.

88. The assembly of claim 86 or 87, wherein each stage is configured to output one of the target-element-rich precipitates.

89. The assembly of any one of claims 81-85, wherein the sequential electrolytic precipitation reactor is a single reactor having two or more outlets, each outlet configured to output one of the target-element-rich precipitates.

90. The assembly of claim 89, wherein the sequential electrolytic precipitation reactor has a pH gradient along the length such that each precipitate forms at a unique outlet.

91. The assembly of any one of claims 81-90, wherein the one or more target elements comprise one or more alkali metals, one or more alkaline earth metals, or one or more transition metals.

92. The assembly of any one of claims 81-91, wherein the one or more target elements comprise one or more alkali metals.

93. The assembly of claim 92, wherein the one or more alkali metals comprise lithium.

94. The assembly of any one of claims 81-93, wherein the one or more target elements comprise one or more alkaline earth metals.

95. The assembly of claim 94, wherein the one or more alkaline earth metals comprise magnesium.

96. The assembly of claim 94 or 95, wherein the one or more alkaline earth metals comprise calcium.

97. The assembly of any one of claims 81-96, wherein the one or more target elements comprise one or more transition metals.

98. The assembly of claim 97, wherein the one or more transition metals comprise nickel, copper, cobalt, and/or cadmium.

99. The assembly of claim 97 or 98, wherein the one or more transition metals comprise nickel.

100. The assembly of any one of claims 97-99, wherein the one or more transition metals comprise copper.

101. The assembly of any one of claims 97-100, wherein the one or more transition metals comprise cobalt.

102. The assembly of any one of claims 97-101, wherein the one or more transition metals comprise cadmium.

103. The assembly of any one of claims 81-102, wherein the sonic probe is configured to provide sonic energy at a frequency of about 18 kHz to about 2 MHz.

104. The method of claim 103, wherein the sonic probe is configured to provide sonic energy at a frequency of about 20 kHz to about 40 kHz.

105. The method of claim 103, wherein the sonic probe is configured to provide sonic energy at a frequency of about 800 kHz to about 1200 kHz.

106. The assembly of claim 103, wherein the sonic probe is configured to provide sonic energy at a frequency of about 18 kHz.

107. The assembly of claim 103, wherein the sonic probe is configured to provide sonic energy at a frequency of about 20 kHz.

108. The assembly of claim 103, wherein the sonic probe is configured to provide sonic energy at a frequency of about 30 KHz.

109. The assembly of claim 103, wherein the sonic probe is configured to provide sonic energy at a frequency of about 40 kHz.

110. The assembly of claim 103, wherein the sonic probe is configured to provide sonic energy at a frequency of about 50 KHz.

111. The assembly of claim 103, wherein the sonic probe is configured to provide sonic energy at a frequency of about 60 kHz.

112. The assembly of claim 103, wherein the sonic probe is configured to provide sonic energy at a frequency of about 70 kHz.

113. The assembly of claim 103, wherein the sonic probe is configured to provide sonic energy at a frequency of about 80 kHz.

114. The assembly of claim 103, wherein the sonic probe is configured to provide sonic energy at a frequency of about 90 KHz.

115. The assembly of claim 103, wherein the sonic probe is configured to provide sonic energy at a frequency of about 100 kHz.

116. The assembly of claim 103, wherein the sonic probe is configured to provide sonic energy at a frequency of about 1000 kHz (1 MHz).

117. The assembly of claim 103, wherein the sonic probe is configured to provide sonic energy at a frequency of about 1100 kHz (1.1 MHz).

118. The assembly of claim 103, wherein the sonic probe is configured to provide sonic energy at a frequency of about 1200 kHz (1.2 MHz).

119. The assembly of claim 103, wherein the sonic probe is configured to provide sonic energy at a frequency of about 1300 kHz (1.3 MHz).

120. The assembly of claim 103, wherein the sonic probe is configured to provide sonic energy at a frequency of about 1400 kHz (1.4 MHZ).

121. The assembly of claim 103, wherein the sonic probe is configured to provide sonic energy at a frequency of about 1500 kHz (1.5 MHz).

122. The assembly of claim 103, wherein the sonic probe is configured to provide sonic energy at a frequency of about 1600 kHz (1.6 MHz).

123. The assembly of claim 103, wherein the sonic probe is configured to provide sonic energy at a frequency of about 1700 kHz (1.7 MHz).

124. The assembly of claim 103, wherein the sonic probe is configured to provide sonic energy at a frequency of about 1800 kHz (1.8 MHz).

125. The assembly of claim 103, wherein the sonic probe is configured to provide sonic energy at a frequency of about 1900 kHz (1.9 MHz).

126. The assembly of claim 103, wherein the sonic probe is configured to provide sonic energy at a frequency of about 2000 kHz (2 MHz).

127. The assembly of any one of claims 81-126, wherein the sonic probe is configured to provide sonic energy at one or more resonant frequencies of the substrate.

128. The assembly of any one of claims 80-126, wherein the one or more substrates comprise particles having a median diameter of 0.5 nm to about 5 mm.

129. The assembly of any one of claims 80-126, wherein the one or more substrates comprise particles having a median diameter of 0.5 nm to about 5 mm.

130. The assembly of claim 128, wherein the one or more substrates comprise particles having a median diameter of 0.5 mm to about 5 mm.

131. The assembly of any one of claims 81-130, wherein the solvent has a pH of about 0 to about 7.

132. The assembly of any one of claims 81-131, wherein the one or more substrates comprise one or more of: fly ash, alkaline wastes, and rocks (e.g., minerals or amorphous phases of minerals).

133. The assembly of any one of claims 81-132, wherein the one or more substrates comprise fly ash.

134. The assembly of any one of claims 81-133, wherein the one or more substrates comprise alkaline wastes.

135. The assembly of any one of claims 81-134, wherein the one or more substrates comprise rocks.

136. The assembly of any one of claims 81-135, wherein dissolution tank further comprises a stirring device.

137. The assembly of any one of claims 81-136, wherein the dissolution tank is configured to operate as a batch reactor.

138. The assembly of any one of claims 81-136, wherein the dissolution tank is configured to operate as a plug flow reactor.

139. The assembly of any one of claims 81-136, wherein the dissolution tank is configured to operate as a continuous flow reactor.

140. The assembly of any one of claims 81-136, wherein the dissolution tank is configured to operate as a fixed-bed reactor.

141. The assembly of any one of claims 81-136, wherein the dissolution tank is configured to operate as a fluidized-bed reactor.

142. The assembly of any one of claims of claims 81-141, wherein the assembly further comprises a sonication probe.
